(19) United States
(12) Patent Application Publication
(10) Pub. No.: US 2026/0276854 A1
(43) Pub. Date: Sep. 17, 2026

(54) PROCEDURE TO CHARACTERIZE SOUND SOURCES WITH EXPERIMENTS REMOVING THE INFLUENCE FROM AN EXPERIMENTAL ACOUSTIC APPARATUS

(71) Applicant: Halliburton Energy Services, Inc., Houston, TX (US)

(72) Inventors: Rafael Mazza BUCHMANN, Rio de Janeiro (BR); Eduardo ALVES DA SILVA, Rio de Janeiro (BR); Leandro Teixeira VIANNA, Rio de Janeiro (BR)

(73) Assignee: Halliburton Energy Services, Inc.---, Houston, TX (US)

(21) Appl. No.: 19/079,662

(22) Filed: Mar. 14, 2025

(51) Int. Cl. G01V 1/50; E21B 47/005; E21B 47/107; E21B 47/117; E21B 49/00

(52) U.S. Cl. CPC G01V 1/50; E21B 47/005; E21B 47/107; E21B 47/117; E21B 49/00

(57) ABSTRACT

Described herein are systems and techniques for improving the accuracy of determinations made using sensed data. Systems of the present disclosure may include a test fixture that includes structural elements that correspond to structural elements of a real wellbore. Systems and techniques of the present disclosure may use acoustic transmitters and acoustic receivers that are deployed in the test fixture such that responses of the test fixture and by proxy responses of the real wellbore may be identified from collected data. Data associated with the identified responses may be subtracted from data collected at the real wellbore such that characteristics of the real wellbore may be identified.

### TECHNICAL FIELD

The present disclosure is generally directed to improving operation of a sensor or sensing apparatus. More specifically, the present disclosure is directed to identifying responses to transmitted acoustic energy associated with a test fixture such that those responses may be removed from data collected at an actual wellbore.

### BACKGROUND

A wellbore or borehole is a hole that is drilled in the ground, often for the purpose of extracting substances (e.g., oil, natural gas, or water) or to provide substances into subterranean structures (e.g., carbon dioxide or hydraulic fracturing fluids). During virtually any phase of wellbore development, acoustic sensors or receivers may be used to collect data from which various determinations may be made. No matter what wellbore application an acoustic sensing system is applied to, removing effects that may distort signals of interest are important to making determinations relating to how to manage a given wellbore.

### BRIEF DESCRIPTION OF THE DRAWINGS

In order to describe the manner in which the features and advantages of this disclosure can be obtained, a more particular description is provided with reference to specific implementations thereof which are illustrated in the appended drawings. Understanding that these drawings depict only exemplary implementations of the disclosure and are not therefore to be considered to be limiting of its scope, the principles herein are described and explained with additional specificity and detail through the use of the accompanying drawings in which:

FIG. 1A is a schematic diagram of an example logging while drilling wellbore operating environment, in accordance with various aspects of the subject technology.

FIG. 1B is a schematic diagram of an example downhole environment having tubulars, in accordance with various aspects of the subject technology.

FIG. 2 illustrates a test fixture and related equipment that may be used to collect data representative of a wellbore tooled with data acoustic sensing devices, in accordance with various aspects of the subject technology.

FIG. 3A illustrates a set of components that may be used to generate, condition, amplify, and provide signals to an acoustic transducer, in accordance with various aspects of the subject technology.

FIG. 3B illustrates a set of components that may be used to sense, amplify, condition, and convert analog signals to binary/digital data that may be stored in a computer data store, in accordance with various aspects of the subject technology.

FIG. 4 illustrates a series of actions that may be used to improve the accuracy of determinations made from data collected in a wellbore by using data acquired in a test fixture, in accordance with various aspects of the subject technology.

FIG. 5 illustrates an example computing device architecture which can be employed to perform any of the systems and techniques described herein.

### DETAILED DESCRIPTION

Various aspects of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous compounds. In addition, numerous specific details are set forth in order to provide a thorough understanding of the methods and apparatus described herein. However, it will be understood by those of ordinary skill in the art that the methods and apparatus described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the present disclosure.

Acoustic sensors/receivers deployed in a wellbore are used to collect data that may be analyzed to identify properties of subterranean strata and/or manmade subterranean strata. For example, subterranean strata may include one or more different types of materials such as granite, sandstone, basalt, water, oil, or natural gas. Examples of manmade subterranean structures include casings that may be cemented into place in a hole drilled into subterranean strata and tubing that may be deployed in a casing. Terms used to refer to such holes or structures built into such holes include well, borehole, and wellbore. Data sensed by the acoustic sensors may be evaluated to identify types of rock that are located at different areas of a borehole, may be used to identify where fluids are flowing through subterranean strata, and may be used to identify the structural integrity of a manmade wellbore structures. In certain instances, acoustic data may be collected using active or passive data collection techniques. Even so, benefits of the present disclosure may especially benefit analysis on data collected using passive acoustic sensing techniques. Active acoustic sensing techniques transmit acoustic energy (sound waves) and receive reflections of transmitted acoustic energy. Examples of active acoustic sensing include ultrasound imaging systems and sonar. Active acoustic sensing may be used to identify types of rock surrounding a borehole or may be used to identify the porosity or permeability of subterranean rock structures.

Passive acoustic sensing techniques sense sound without relying on a transmitter to transmit acoustic energy. As such, passive acoustic sensing techniques listen to sounds generated by a source that is not part of a sensing system. When an acoustic sensor (receiver) is deployed in a wellbore, that sensor may sense sounds generated when subterranean fluids move through strata of the Earth and may sense sounds that could be indicative of a wellbore defect. Passive acoustic sensing may be used to listen for fluid leaks. For example, passive acoustic sensing may be used to detect defects in cement that holds a casing in place or may be used to identify whether a wellbore casing or tube is leaking.

Active acoustic sensing techniques may both transmit and receive acoustic energy. Data acquired from active acoustic sensing techniques may be used to generate images of subterranean features that passive acoustic sensing techniques may not be able to detect. Techniques of the present disclosure may be directed to improving accuracy of determinations made especially when passive acoustic sensing techniques are used to detect wellbore defects. As such, techniques of the present disclosure may help ensure that the real wellbore can be certified for use.

Elements used to construct a wellbore such as wellbore casings or wellbore tubes may concentrate, reflect, or otherwise distort noises indicative of defects or leaks in wellbore structures. This means that structures of a wellbore can distort noises indicative of wellbore defects or leaks. Since determinations are made from data acquired using either passive or active acoustic sensing techniques, such distortions may affect the reliability of those determinations. This means that removing effects of wellbore distortions may be important to increasing the accuracy of determinations made by computers that analyze sets of acquired acoustic data. Described herein are systems, apparatuses, processes (also referred to as methods), and computer-readable media (collectively referred to as “systems and techniques” for improving accuracy of determinations made from sensed data. Examples of the systems and techniques described herein are illustrated in the figures that follow.

In order to safely and efficiently extract resources from or to sequester materials into a subterranean environment, one should understand the characteristics of the subterranean environment and characteristics of wellbore structures that perform operations associated with the subterranean environment. As such, characterizing the environment where wellbores are placed is a crucial step in oil and gas industry. Furthermore, the complexities of a wellbore can significantly increase the challenge of extracting resources from the subterranean environment. Acoustical analysis is one method that may be used to evaluate the structure of the wellbore or that may be used to identify characteristics of the subterranean environment where the wellbores are located. Systems and techniques of the present disclosure may collect data at a test fixture that has a wellbore-like structure and then to use the data collected at the test fixture to improve evaluations made regarding the condition of a real wellbore. A test fixture that emulates at least some of the main characteristics of a real wellbore combined with computer simulations that simulate how a wellbore operates can be used to increase the accuracy of determinations made from data collected at the real wellbore. A real wellbore here refers a wellbore that is extends from the surface (e.g., the Earth's surface) into subterranean strata (e.g., strata of the Earth). Such real wellbores may include a casing, one or more sets of tubing, and other structures (e.g., cement that adheres the casing to the subterranean strata).

Techniques of the present disclosure may acquire frequency response data of a test fixture that has a wellbore-like structure. Influences of the test fixture on predetermined or well-known sounds and sound sources allow for the deep study of the sound propagation in a test fixture that has the wellbore-like structure. By measuring magnitudes of sounds traveling through the test fixture that is built with characteristics that are similar to a real wellbore may help remove effects of the real wellbore from data collected at the real wellbore. The more closely the wellbore-like structure of the test fixture tracks the real wellbore, the more closely acoustic responses collected in the wellbore-like test fixture will track acoustic responses of the real wellbore. Because of this, by knowing the acoustic responses of the test fixture, particular influences of the fixture itself may be used to remove similar influences from sets of acoustic data collected at a real wellbore. Computer simulations and field test results may allow for real wellbore response data and its adjacencies to filter datasets collected at real wellbores even when these real wellbores include many layers of materials that have different material properties.

This disclosure addresses an experimental procedure that can be used to characterize a wellbore acoustic signature. Complementary to computer simulations, the experimental apparatus is used as a closer approximation to real situations, enabling a better understanding of phenomena that may only occur there. With these situations addressed, unwanted effects can be removed, and the desired events can be isolated and better understood. This may be a necessary step in decoupling the acoustic signature of the source from the response of the experimental apparatus that simulates a wellbore environment.

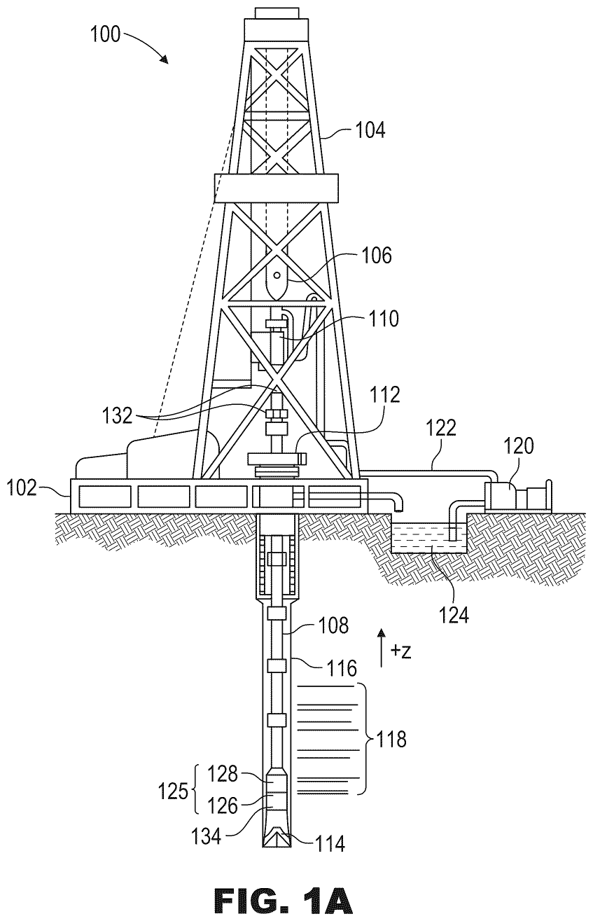

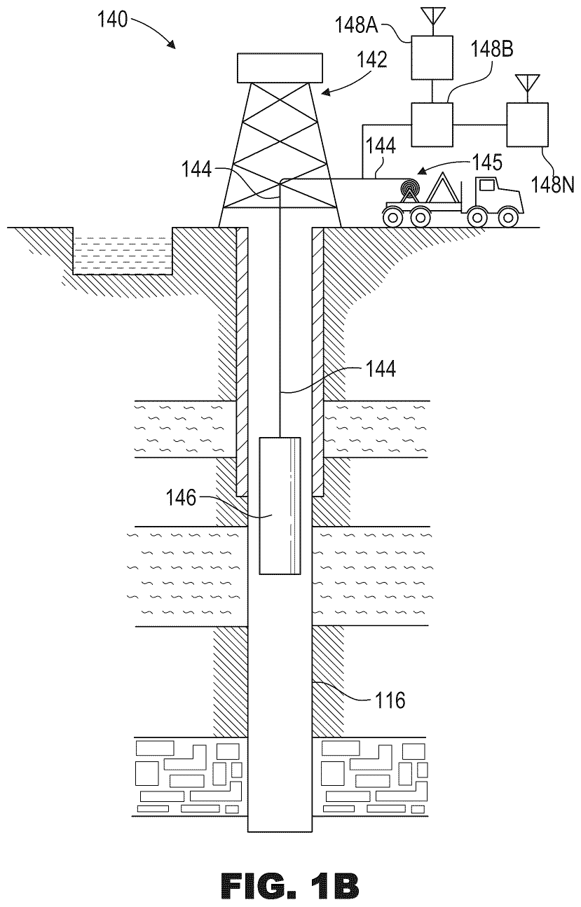

FIG. 1A is a schematic diagram of an example logging while drilling wellbore operating environment, in accordance with various aspects of the subject technology. The drilling arrangement shown in FIG. 1A provides an example of a logging-while-drilling (commonly abbreviated as LWD) configuration in a wellbore drilling scenario 100. The LWD configuration can incorporate sensors (e.g., EM sensors, seismic sensors, gravity sensor, image sensors, etc.) that can acquire formation data, such as characteristics of the formation, components of the formation, etc. For example, the drilling arrangement shown in FIG. 1A can be used to gather formation data through an imager tool (not shown) as part of logging the wellbore using the imager tool. The drilling arrangement of FIG. 1A also exemplifies what is referred to as Measurement While Drilling (commonly abbreviated as MWD) which utilizes sensors to acquire data from which the wellbore's path and position in three-dimensional space can be determined. FIG. 1A shows a drilling platform 102 equipped with a derrick 104 that supports a hoist 106 for raising and lowering a drill string 108. The hoist 106 suspends a top drive 110 suitable for rotating and lowering the drill string 108 through a well head 112. A drill bit 114 can be connected to the lower end of the drill string 108. As the drill bit 114 rotates, it creates a wellbore 116 that passes through various subterranean formations 118. A pump 120 circulates drilling fluid through a supply pipe 122 to top drive 110, down through the interior of drill string 108 and out orifices in drill bit 114 into the wellbore. The drilling fluid returns to the surface via the annulus around drill string 108, and into a retention pit 124. The drilling fluid transports cuttings from the wellbore 116 into the retention pit 124 and the drilling fluid's presence in the annulus aids in maintaining the integrity of the wellbore 116. Various materials can be used for drilling fluid, including oil-based fluids and water-based fluids.

Logging tools 126 can be integrated into the bottom-hole assembly 125 near the drill bit 114. As drill bit 114 extends into the wellbore 116 through the formations 118 and as the drill string 108 is pulled out of the wellbore 116, logging tools 126 collect measurements relating to various formation properties as well as the orientation of the tool and various other drilling conditions. The logging tool 126 can be applicable tools for collecting measurements in a drilling scenario, such as the imager tools described herein. Each of the logging tools 126 may include one or more tool components spaced apart from each other and communicatively coupled by one or more wires and/or other communication arrangement. The logging tools 126 may also include one or more computing devices communicatively coupled with one or more of the tool components. The one or more computing devices may be configured to control or monitor a performance of the tool, process logging data, and/or carry out one or more aspects of the methods and processes of the present disclosure.

The bottom-hole assembly 125 may also include a telemetry sub 128 to transfer measurement data to a surface receiver 132 and to receive commands from the surface. In at least some cases, the telemetry sub 128 communicates with a surface receiver 132 by wireless signal transmission (e.g., using mud pulse telemetry, EM telemetry, or acoustic telemetry). In other cases, one or more of the logging tools 126 may communicate with a surface receiver 132 by a wire, such as wired drill pipe. In some instances, the telemetry sub 128 does not communicate with the surface, but rather stores logging data for later retrieval at the surface when the logging assembly is recovered. In at least some cases, one or more of the logging tools 126 may receive electrical power from a wire that extends to the surface, including wires extending through a wired drill pipe. In other cases, power is provided from one or more batteries or via power generated downhole.

Collar 134 is a frequent component of a drill string 108 and generally resembles a very thick-walled cylindrical pipe, typically with threaded ends and a hollow core for the conveyance of drilling fluid. Multiple collars 134 can be included in the drill string 108 and are constructed and intended to be heavy to apply weight on the drill bit 114 to assist the drilling process. Because of the thickness of the collar's wall, pocket-type cutouts or other type recesses can be provided into the collar's wall without negatively impacting the integrity (strength, rigidity and the like) of the collar as a component of the drill string 108.

FIG. 1B is a schematic diagram of an example downhole environment having tubulars, in accordance with various aspects of the subject technology. In this example, an example system 140 is depicted for conducting downhole measurements after at least a portion of a wellbore has been drilled and the drill string removed from the well. An imager tool (not shown) can be operated in the example system 140 shown in FIG. 1B to log the wellbore. A downhole tool is shown having a tool body 146 in order to carry out logging and/or other operations. For example, instead of using the drill string 108 of FIG. 1A to lower the downhole tool, which can contain sensors and/or other instrumentation for detecting and logging nearby characteristics and conditions of the wellbore 116 and surrounding formations, a wireline conveyance 144 can be used. The tool body 146 can be lowered into the wellbore 116 by wireline conveyance 144. The wireline conveyance 144 can be anchored in the drill rig 142 or by a portable means such as a truck 145. The wireline conveyance 144 can include one or more wires, slicklines, cables, and/or the like, as well as tubular conveyances such as coiled tubing, joint tubing, or other tubulars. The downhole tool can include an applicable tool for collecting measurements in a drilling scenario, such as the imager tools described herein.

The illustrated wireline conveyance 144 provides power and support for the tool, as well as enabling communication between data processors 148A, 148B, through 148N (148A-N) on the surface. In some examples, wireline conveyance 144 can include electrical and/or fiber optic cabling for carrying out communications. The wireline conveyance 144 is sufficiently strong and flexible to tether the tool body 146 through the wellbore 116, while also permitting communication through the wireline conveyance 144 to one or more of the processors 148A-N, which can include local and/or remote processors. The processors 148A-N can be integrated as part of an applicable computing system, such as the computing device architectures described herein. Moreover, power can be supplied via wireline conveyance 144 to meet power requirements of the tool. For slickline or coiled tubing configurations, power can be supplied downhole with a battery or via a downhole generator.

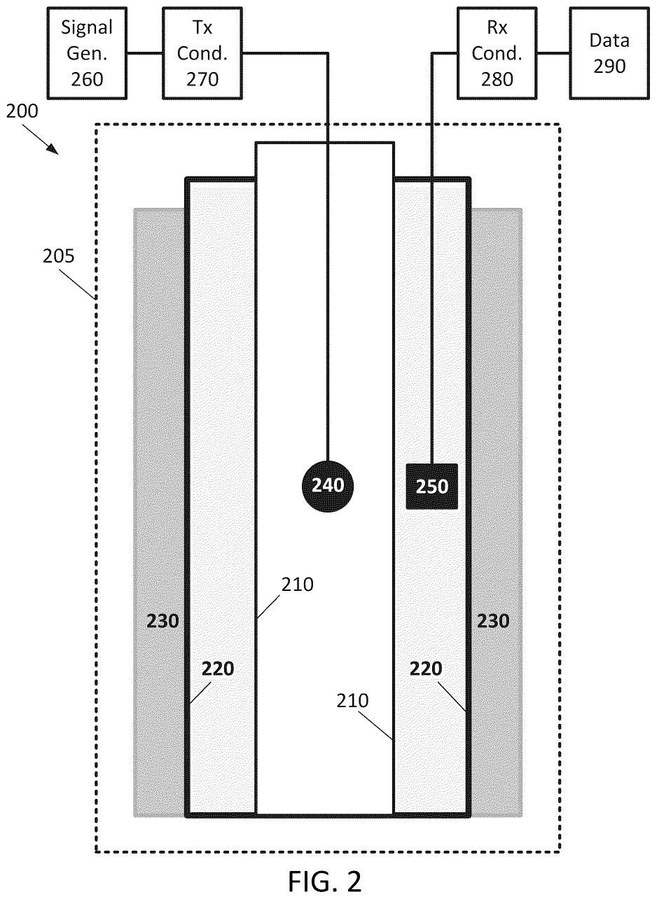

FIG. 2 illustrates a test fixture and related equipment that may be used to collect data representative of a wellbore tooled with data acoustic sensing devices. The test fixture 200 of FIG. 2 includes tube 210, casing 220, and cement sheath 230. Sensing devices of FIG. 2 include acoustic transmitter 240, acoustic receiver/hydrophone 250, signal generator 260, transmit signal conditioner 270, receiver conditioner 280, and data storage 290.

Functions of signal generator 260 and transmitter conditioner 270 may be performed using analog circuits, digital circuits, or a combination of both analog and digital circuits. When digital circuits are used, signals may be generated using a processor or computer that provides data (e.g., a data stream) to a digital to analog converter. When a data stream is used, signals that contain spectral content from one or multiple frequencies may be generated as long as the processor or computer provides data that meets the Nyquist criteria where at least two data points are provided for each respective frequency represented by the data in the data stream.

In other instances, a processor or computer may send commands to circuits that are configured or programmed to generate analog signals by providing values to a signal generation circuit. Such a configuration may be referred to as an arbitrary signal generator (ASG). For example, a digital value of 1010 may be used to configure an ASG to generate a 10 kilohertz (kHz) signal. Such a function may be implemented by a computer providing the value of 1010 to a multiplexer that has outputs coupled to a set of transistor selection switches (e.g., field effect crossbar switches). The value provided to the multiplexer may set an output of the multiplexer to a state that changes values of resistance, capacitance, and/or inductance of an oscillator circuit. Different binary values provided to the multiplexer may be used to set different frequencies generated by signal generator 260.

Transmit conditioner 270 may amplify and/or filter signals generated by signal generator 260. Signals output by transmit conditioner 270 may be provided to acoustic transmitter 240 and acoustic transmitter may transform an electrical signal provided to it into a pressure wave of acoustic energy. As such, signals provided to acoustic transmitter 240 may cause acoustic transmitter 240 to emit acoustic energy toward wall of tube 210 and portions of this energy may pass through the wall of tube 210 toward acoustic receiver/hydrophone 250.

The acoustic energy travels from transmitter 240 (tx) to receiver 250 (rx), being affected only by the test fixture 200 (h). The transmitter 240 may be considered to accurately be a fixed source and test fixture 200 may be considered as a system operating in a steady state condition. Accordingly, interrelationships between time, frequency, and signal magnitude (dB) of the system of test fixture 200 may be represented by the equations below.

Equation 1 below shows that energy received rx(t) by acoustic receiver/hydrophone 250 may be expressed in the time domain as a function of the convolution of transmitted energy over time tx(t) with the wellbore response over time h(t). Equations 2 and 3 show the same or similar relationship in the frequency domain. The difference between equation 2 and equation 3 is that equation 2 is a general form in the frequency domain and equation 3 shows the relationship using signal magnitudes in decibels. Convolution included in equation 1 is the integral of a product of a first function of transmitted acoustic energy tx over time and a second function of wellbore response h (t) over time.

$$rx ( t ) = ( tx * h ) ( t ) = {\int }_{- ∞}^{+ ∞} tx ( τ ) \cdot h ( t - τ ) dτ \qquad Equation 1$$

$$RX ( f ) = TX ( f ) \cdot H ( f ) \qquad Equation 2$$

$${RX}_{dB} ( f ) = {TX}_{dB} ( f ) + {H}_{dB} ( f ) \qquad Equation 3$$

Various layers of test fixture 200 may be built in a manner similar to an actual wellbore. For example, when steel casings are used in a wellbore, steel casings may be built into the test fixture. In another example, when tubing located in a wellbore is made of plastic or some polymer material, the same types of materials may be used to make the tubing included in the test fixture. In some instances, pieces of casing or tubing may have some of the same dimensions (e.g., inner diameter and outer diameter) of corresponding pieces of casing or tubing included in the test fixture. In other instances, the test fixture may be built with proportionally sized pieces of casing or tubing. Areas located between walls of tubing or casing may also be filled with one fluid or another. For example, tube 210 may be filled with air and casing 220 may be filled with water. Test fixture 200 may also include a structure that surrounds test fixture 200. This means that tube 210, casing 220, and/or cement sheath 230 may be placed within an enclosure represented by dashed line 205. In such instances, the enclosure may allow for temperatures used to collect data from the model to be controlled more easily. Layers of the test fixture 200 may include, yet may not be limited to tube 210, casing 220, and cement sheath 230. In certain instances, the test fixture 200 may not include a cement sheath. Some layers may include or be composed mostly of water, mud, oil, cement, metal, or plastic.

The overall length or height of tubes, casings, or other materials used to make a test fixture may be much longer than the width of the test fixture. For example, the length of a casing in the test fixture may be 10 times (10×) the diameter of a casing used in the test fixture. This 10× factor is used here as an example as the goal of mitigating discontinuities or reflections that may distort collected data when emitted waves of acoustic energy reach an end point (an edge or boundary) of a casing or tube of the test fixture. When lengths of casing or tubing are sufficiently large as compared to the width of the casing or tubing, the system may effectively simulate a wellbore of “effectively” infinite length.

To further mitigate such edge effects, sets of collected data may be partitioned in time ranges with a round-trip time (or portion of a round trip time) associated with the speed of sound through a layer or medium of the test fixture, a layer or medium through which sound wave travels the fastest may be used to establish the time range used to partition a set of collected data. One significant interest in using such a test fixture relates to the propagation of acoustic energy in the frequency domain. As such, the frequency response of the fixture may be identified using techniques of the present disclosure. A common way to represent magnitudes of propagated signals is by using decibels. Each one of the terms can be composed by the necessary conditioning and the transduction of mechanical (acoustic/sound) in electrical energy. So, in dB:

$$TX = Generated Signal + Transmission Gain + Transmission Transduction$$

$$RX = Reception Transduction + Reception Gain + Received Signal$$

The generated signal may be chosen to be a single or sum of sinusoidal waves, with known amplitudes and frequencies. The generated signal may include sinusoids as specified by the relationship:

$$Generated Signal = {\sum }_{n = 1}^{i} {A}_{n} \cdot sin ( 2 \cdot π \cdot {f}_{n} \cdot t )$$

The transmission gain may be chosen or set to be high enough so the received signal can be detected with sufficient signal magnitudes. The transmission gain may depend on characteristics of the acoustic transmitter (e.g., an acoustic transducer). When possible, the acoustic transmitter/transducer and related circuits may be set to generate waveforms of equal amplitudes for the different frequencies emitted by the acoustic transmitter/transducer. As such, the transmission gain may be selected based on properties of the acoustic transmitter (e.g., an acoustic transducer). Adjusting the transmission gain may help mitigate the effects of noise that could potentially affect resolution of the system. Since test fixture 200 may be placed in an isolated environment (e.g., within a building or other structure) the fact that the fixture is isolated will help prevent external noise from affecting the system.

The transmission transduction may be defined as the sensitivity of the transmitter and this transmitter sensitivity may be measured or represented in units of Pascals per Volt. The reception transduction may be defined as the sensitivity of the receiver, and receiver sensitivity may be measured or represented in Volts per Pascal. The reception gain may be set to maximize the received signal amplitude or power. The reception gain may be set by adjusting the gain of the amplifier that receives a signal from an acoustic sensor (e.g., a signal sensed by a hydrophone). The gain is also set such that received waveforms are above any noise. Techniques of the present disclosure may receive, acquire, and log (e.g., store) acoustic data.

To generate the electrical signal, signal generator 260 may be in the form of an arbitrary signal generator (ASG). Since the ASG or other types of signal generators may not reach the power and voltage requirements to power an acoustic transmitter (e.g., an underwater acoustic transmitter), a power amplifier (e.g., signal conditioner 270) may be required to boost the power of the generated signal. At this point, the signal generated can be properly transformed into a sound pressure wave. This sound pressure wave may propagate through mediums and structures of a wellbore or wellbore like test fixture even when that wellbore or test fixture includes many layers.

The generated signal may be chosen to be a single sinusoid or a sum of sinusoids that have a known amplitude and frequency (fₙ). Equation 4 shows that the generated signal may be a sum of sine waves of frequencies n=1 (a first frequency) to n=i (a last frequency) that each may have a respective amplitude A. The “t” in equation 4 below indicates that generated sinusoidal waveforms may vary with time.

$$Generated Signal = {\sum }_{n = 1}^{i} {A}_{n} \cdot sin ( 2 \cdot π \cdot {f}_{n} \cdot t ) \qquad Equation 4$$

Acoustic energy received by acoustic receiver/hydrophone 250 may be converted into signals that are provided to receiver conditioner 280 and signals output from receiver conditioner 280 may be converted into binary data and stored in data store 290. The conversion of such analog signals may be performed using an analog to digital converter.

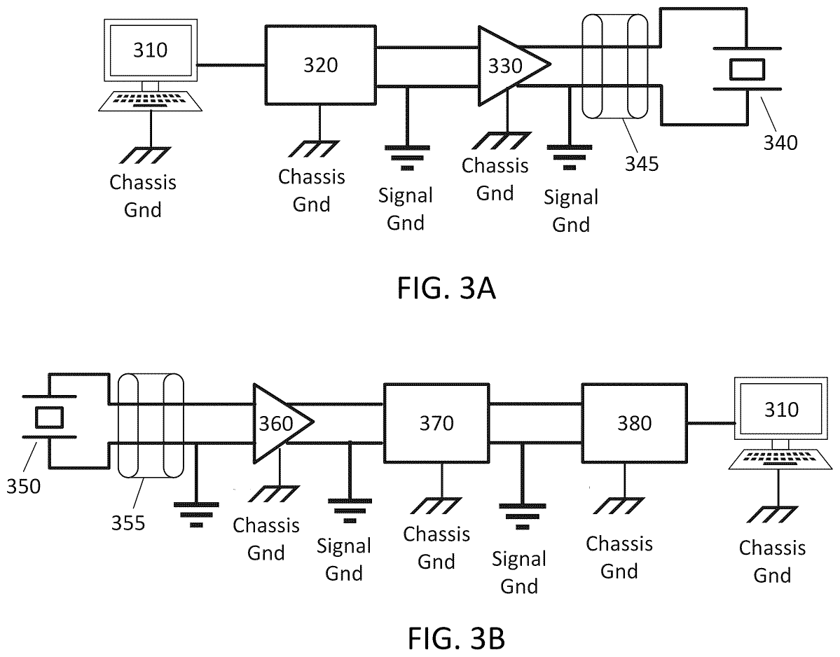

FIG. 3A illustrates a set of components that may be used to generate, condition, amplify, and provide signals to an acoustic transducer. The signals provided to the acoustic transducer may cause that transducer to emit acoustic energy. The components of FIG. 3A may be used to generate the signals and acoustic energy discussed in respect to FIG. 2. FIG. 3A includes computer 310 may provide a data stream to circuits 320 that convert the data stream to analog signals. Such a function may be performed by an analog to digital converter. The analog signals output by circuits 320 may be provided to amplifier 330 and amplified signals output by amplifier 330 may be used to simulate acoustic transmitter 340. Signals provided to acoustic transmitter 340 may be provided via wires or conduit (e.g., a coaxial cable) 345. FIG. 3A also shows two different grounds that may be used in certain instances. These grounds are chassis ground and signal ground. The use of separate grounds may assist in preventing noise being coupled from certain pieces of equipment (e.g., computer 310 or power supplies) from being superimposed onto signals generated by the components of FIG. 3A. FIG. 3B also shows both a chassis ground and a signal ground that may be connected to various components.

FIG. 3B illustrates a set of components that may be used to sense amplify, condition, and convert analog signals to binary/digital data that may be stored in a computer data store. FIG. 3B includes acoustic receiver 350, wires/conduit 355 (e.g., a coaxial cable), amplifier 360, signal conditioner/bandpass filter 370, data acquisition circuits 380 (e.g., an analog to digital converter), and computer 310. Acoustic energy sensed by acoustic receiver 350 may be converted into electrical signals via wires/conduit 355 to amplifier 360. Amplifier 360 may then provide an amplified signal to signal conditioning circuit 370 that may be a bandpass filter. The bandpass filter may remove or attenuate unwanted noise or signals that may typically have spectral content that is either below or above the spectral content typical to signals of interest. Such signals of interest may be associated with the movement of fluids or sounds associated with damaged wellbore structures. For example, a voids or cracks in cement that binds a casing to subterranean strata may produce signals of interest when fluids move through such voids or cracks.

After sensed signals are amplified and filtered, those signals may be provided to data acquisition circuit 380 that converts the analog signals to a set of digital data. This set of digital data may then be received by computer 310, where computer 310 may store that data. Computer 310 may also run instructions associated with computations or simulations when performing techniques of the present disclosure.

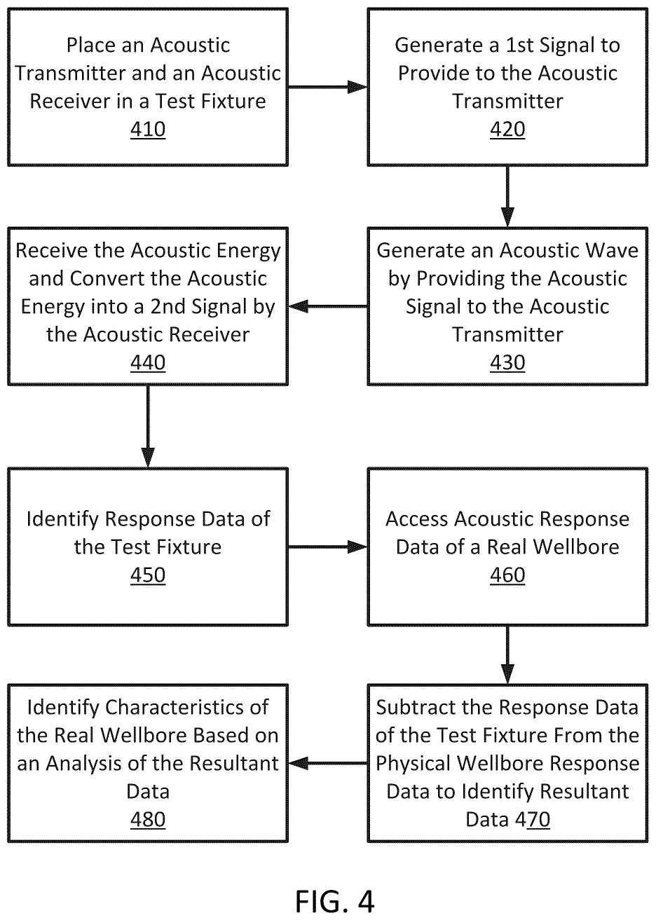

FIG. 4 illustrates a series of actions that may be used to improve the accuracy of determinations made from data collected in a wellbore by using data acquired in a test fixture, in accordance with various aspects of the subject technology. At block 410 an acoustic transmitter and an acoustic receiver may be placed in a test fixture that may include structures that are similar to a real wellbore. As discussed in respect to FIG. 2, a test fixture may be built above ground, and the test fixture may be placed in a building or other enclosure. As shown in FIG. 2, the transmitter may be placed in the midway position of a tube that is located within a casing and the receiver may be placed in a midway position of the casing. The term midway here refers to midpoints of the total length of the tube or casing such that the transmitter and the receiver will each be located at a maximum distance from an edge of the tube or casing.

The tube and or casing may be filled with a fluid or a substance. Here again, the tube may be filled with air and the casing may be filled with water, of course other fluids may be used. At block 420 a first signal may be generated by a signal generator, potentially using circuits analog and/or digital electronics as discussed above. This first signal may be a sinusoid of a single frequency, may be a combination of sinusoids of different frequencies, or may contain spectral content incorporated into a data stream where the data stream is converted into an analog signal. When this first signal is provided to an acoustic transmitter, the acoustic transmitter may convert that signal into an acoustic pressure wave at block 430.

Energy of the acoustic wave will then travel toward structures of the test fixture. When the transmitter is placed in a tube of the test fixture, a first portion of the energy in the acoustic wave may be reflected off an inner surface of the tube, a second portion of the energy may propagate along the tube, and a third portion of the energy may propagate through the tube. Acoustic energy that propagates through the tube may pass through a fluid that fills the casing. Here again, respective portions of acoustic energy may move in different directions, some may move toward the acoustic receiver, some may move along the casing, and some may move through the casing.

At block 440, the acoustic receiver may receive acoustic energy through a relatively direct path or through indirect paths. The acoustic energy received by the acoustic receiver will correspond to a response of the test fixture to the acoustic energy transmitted from the acoustic transmitter. At block 450, data that forms or is representative of the test fixture response (i.e., response data of the test fixture) may be collected. As such, the response of the test fixture may be identified.

Many different signals may be provided to the test fixture when response data of the test fixture are collected. In some instances, discrete sinusoids of specific frequencies may be provided to the acoustic transmitter such that response data of the test fixture may be collected. For example, sinusoids of 1 thousand hertz (kHz), 2 kHz, 5 kHz, and 10 kHz may be used in a data collection process.

At block 460 data collected in a real wellbore may be accessed. Here again, the test fixture may be built with similar characteristics of the real wellbore. Next, at block 470, response data of the test fixture may be subtracted from response data of the real wellbore.

At block 480, the real wellbore data with data of the test fixture response data may be analyzed to identify characteristics of the wellbore more accurately than before. Such techniques may be used to identify locations of wellbore leaks or other wellbore defects (cement voids) are located. Sounds associated with such wellbore defects or leaks may be referred to as signals of interest. The analysis may also be used to identify characteristics of strata that surround the wellbore or may be used to identify locations where fluids are moving in strata of the wellbore. Characteristics of the wellbore strata that may be identified may also include identifying the porosity or permeability of wellbore strata at different locations. Specific portions of real wellbore data collected, and determinations made using these data may be associated with specific wellbore locations of the real wellbore.

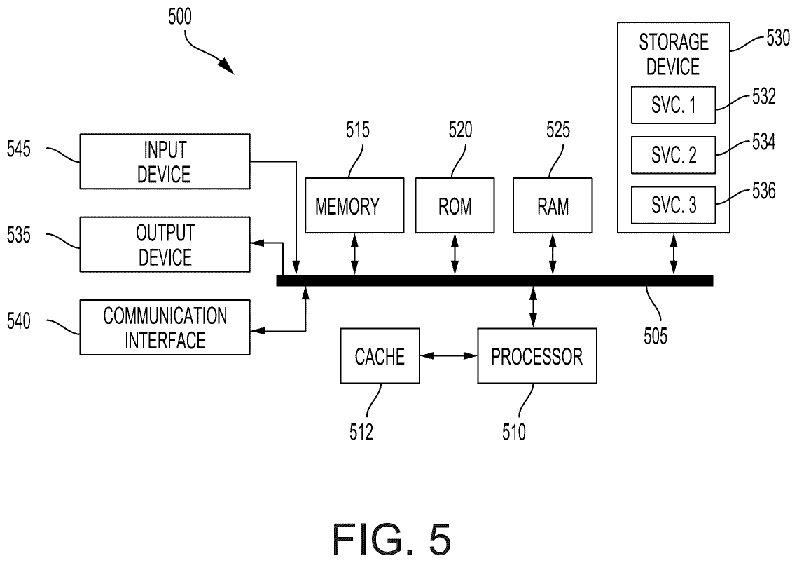

FIG. 5 illustrates an example computing device architecture which can be employed to perform any of the systems and techniques described herein. In some examples, the computing device 500 architecture can be integrated with tools described herein. The components of the computing device architecture 500 are shown in electrical communication with each other using a connection 505, such as a bus. The example computing device architecture 500 includes a processing unit (CPU or processor) 510 and a computing device connection 505 that couples various computing device components including the computing device memory 515, such as read only memory (ROM) 520 and random access memory (RAM) 525, to the processor 510.

The computing device architecture 500 can include a cache of high-speed memory connected directly with, in close proximity to, or integrated as part of the processor 510. The computing device architecture 500 can copy data from the memory 515 and/or the storage device 530 to the cache 512 for quick access by the processor 510. In this way, the cache can provide a performance boost that avoids processor 510 delays while waiting for data. These and other modules can control or be configured to control the processor 510 to perform various actions. Other computing device memory 515 may be available for use as well. The memory 515 can include multiple different types of memory with different performance characteristics. The processor 510 can include any general-purpose processor and a hardware or software service, such as service 1 532, service 2 534, and service 3 536 stored in storage device 530, configured to control the processor 510 as well as a special-purpose processor where software instructions are incorporated into the processor design. The processor 510 may be a self-contained system, containing multiple cores or processors, a bus, memory controller, cache, etc. A multi-core processor may be symmetric or asymmetric.

To enable user interaction with the computing device architecture 500, an input device 545 can represent any number of input mechanisms, such as a microphone for speech, a touch-sensitive screen for gesture or graphical input, keyboard, mouse, motion input, speech and so forth. An output device 535 can also be one or more of a number of output mechanisms known to those of skill in the art, such as a display, projector, television, speaker device, etc. In some instances, multimodal computing devices can enable a user to provide multiple types of input to communicate with the computing device architecture 500. The communications interface 540 can generally govern and manage the user input and computing device output. There is no restriction on operating on any particular hardware arrangement and therefore the basic features here may easily be substituted for improved hardware or firmware arrangements as they are developed.

Storage device 530 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 525, read only memory (ROM) 520, and hybrids thereof. The storage device 530 can include services 532, 534, 536 for controlling the processor 510. Other hardware or software modules are contemplated. The storage device 530 can be connected to the computing device connection 505. In one aspect, a hardware module that performs a particular function can include the software component stored in a computer-readable medium in connection with the necessary hardware components, such as the processor 510, connection 505, output device 535, and so forth, to carry out the function.

For clarity of explanation, in some instances the present technology may be presented as including individual functional blocks including functional blocks comprising devices, device components, steps or routines in a method implemented in software, or combinations of hardware and software.

In some instances, the computer-readable storage devices, mediums, and memories can include a cable or wireless signal containing a bit stream and the like. However, when mentioned, non-transitory computer-readable storage media expressly exclude media such as energy, carrier signals, waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples and aspects thereof, but those skilled in the art will recognize that the application is not limited thereto. Thus, while illustrative examples and aspects of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, examples and aspects of the systems and techniques described herein can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Methods and apparatus of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Such methods may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Aspects of the invention include:
Aspect 1: A method comprising emitting a pulse of acoustic energy from an acoustic transmitter deployed in a test fixture; receiving at least a portion of the pulse of acoustic energy by an acoustic receiver deployed in the test fixture, wherein the receipt of the at least portion of the pulse acoustic energy by the acoustic receiver results in a received signal being generated by the acoustic receiver; converting the received signal into a set of digital data indicative of a test fixture response; identifying the test fixture response based on an analysis on the set of digital data; generating resultant data associated with one or more characteristics of a real wellbore based on a comparison between data sensed at the real wellbore with the set of digital data indicative of the test fixture response; and identifying the one or more characteristics of the real wellbore based on an analysis of the resultant data.
Aspect 2: The method of Aspect 1, further comprising: deploying the acoustic transmitter and the acoustic receiver in the test fixture that includes a set of structural elements that correspond to a group of structural elements of a real wellbore, wherein the comparison comprises subtracting data from the set of data indicative of the test fixture response from the data sensed at the real wellbore.
Aspect 3: The method of Aspect 1 or 2, further comprising: generating a first signal at a signal generator; and providing the first signal to the acoustic transmitter, wherein the acoustic energy is emitted from the acoustic transmitter based on the first signal being provided to the acoustic transmitter.
Aspect 4: The method of any of Aspects 1 through 3, further comprising: emitting one or more additional pulses of acoustic energy from the acoustic transmitter; a receiving additional portions of acoustic energy associated with the one or more pulses of acoustic energy received by the acoustic receiver; and converting the additional portions of acoustic energy into data that is included in the set of digital data.
Aspect 5: The method of any of Aspects 1 through 4, wherein the pulse of acoustic energy and the one or more additional pulses of acoustic energy have different spectral content.
Aspect 6: The method of any of Aspects 1 through 5, wherein the pulse of acoustic energy and the one or more additional pulses of acoustic energy have different spectral content each are associated with a specific sinusoid frequency.
Aspect 7: The method of any of Aspects 1 through 6, further comprising: collecting data at the real wellbore via one or more acoustic sensors of a passive acoustic sensing system, wherein the data associated with the one or more characteristics of the real wellbore are associated with specific locations or depths of the real wellbore.
Aspect 8: A non-transitory computer-readable storage medium having embodied thereon instructions that when executed by one or more processors that cause the one or more processors to: initiate an acoustic transmitter deployed in a test fixture to emit a of pulse of acoustic energy, wherein: at least a portion of the pulse of acoustic energy is received by an acoustic receiver deployed in the test fixture, the receipt of the at least portion of the pulse acoustic energy by the acoustic receiver results in a received signal being generated by the acoustic receiver, and the received signal is converted into a set of digital data indicative of a test fixture response; identify the test fixture response based on an analysis on the set of digital data; generate resultant data associated with one or more characteristics of a real wellbore based on a comparison between data sensed at the real wellbore with the set of digital data indicative of the test fixture response; and identify the one or more characteristics of the real wellbore based on an analysis of the resultant data.
Aspect 9: The non-transitory computer-readable storage medium of Aspect 8, wherein the execution of the instructions cause the one or more processors to: control deployment of the acoustic transmitter and the acoustic receiver in the test fixture that includes a set of structural elements that correspond to a group of structural elements of a real wellbore, wherein the comparison comprises subtracting data from the set of data indicative of the test fixture response from the data sensed at the real wellbore.
Aspect 10: The non-transitory computer-readable storage medium of Aspect 8 or 9, wherein the execution of the instructions cause the one or more processors to: control generation of a first signal at a signal generator, wherein the first signal is provided to the acoustic transmitter, wherein the acoustic energy is emitted from the acoustic transmitter based on the first signal being provided to the acoustic transmitter.
Aspect 11: The non-transitory computer-readable storage medium of any of Aspects 8 through 10, wherein the execution of the instructions cause the one or more processors to: initiate emission of one or more additional pulses of acoustic energy from the acoustic transmitter, wherein: additional portions of acoustic energy associated with the one or more pulses of acoustic energy received by the acoustic receiver are received, and the additional portions of acoustic energy are converted into data that is included in the set of digital data.
Aspect 12: The non-transitory computer-readable storage medium of any of Aspects 8 through 11, wherein the pulse of acoustic energy and the one or more additional pulses of acoustic energy have different spectral content.
Aspect 13: The non-transitory computer-readable storage medium of any of Aspects 8 through 11, wherein the pulse of acoustic energy and the one or more additional pulses of acoustic energy have different spectral content each are associated with a specific sinusoid frequency.
Aspect 14: The non-transitory computer-readable storage medium of any of Aspects 8 through 13, wherein: data is collected at the real wellbore is based on deployment of one or more acoustic sensors at the real wellbore, wherein the data associated with the one or more characteristics of the real wellbore are associated with specific locations or depths of the real wellbore.
Aspect 15: An apparatus comprising: a test fixture that includes a set of structural elements that correspond to a group of structural elements of a real wellbore; an acoustic transmitter deployed in the test fixture that emits a pulse of acoustic energy, wherein: an acoustic receiver deployed in the test fixture that receives at least a portion of the pulse of acoustic energy, wherein: the receipt of the at least portion of the pulse acoustic energy by the acoustic receiver results in a received signal being generated by the acoustic receiver, and the received signal is converted into a set of digital data indicative of a test fixture response; a memory; and one or more processors that execute instructions out of the memory to: identify the test fixture response based on an analysis on the set of digital data, generate resultant data associated with one or more characteristics of a real wellbore based on a comparison between data sensed at the real wellbore with the set of digital data indicative of the test fixture response, and identify the one or more characteristics of the real wellbore based on an analysis of the resultant data.
Aspect 16, the apparatus of Aspect 15, wherein the execution of the instructions cause the one or more processors to: control operation of the acoustic transmitter and the acoustic receiver in the test fixture that includes the set of structural elements that correspond to a group of structural elements of the real wellbore, wherein the comparison comprises subtracting data from the set of data indicative of the test fixture response from the data sensed at the real wellbore.
Aspect 17: The apparatus of Aspect 15 or 17, wherein the execution of the instructions cause the one or more processors to: control generation of a first signal at a signal generator, wherein the first signal is provided to the acoustic transmitter, wherein the acoustic energy is emitted from the acoustic transmitter based on the first signal being provided to the acoustic transmitter.
Aspect 18: The apparatus of any of Aspects 15 through 18, wherein the execution of the instructions cause the one or more processors to: initiate emission of one or more additional pulses of acoustic energy from the acoustic transmitter, wherein: additional portions of acoustic energy associated with the one or more pulses of acoustic energy are received by the acoustic receiver, and the additional portions of acoustic energy are converted into data that is included in the set of digital data.
Aspect 19: The apparatus of any of Aspects 15 through 18, wherein the pulse of acoustic energy and the one or more additional pulses of acoustic energy have different spectral content.
Aspect 20: The apparatus of any of Aspects 15 through 19, wherein the pulse of acoustic energy and the one or more additional pulses of acoustic energy have different spectral content each are associated with a specific sinusoid frequency.

What is claimed is:

1. A method comprising:
emitting a pulse of acoustic energy from an acoustic transmitter deployed in a test fixture;
receiving at least a portion of the pulse of acoustic energy by an acoustic receiver deployed in the test fixture, wherein the receipt of the at least portion of the pulse acoustic energy by the acoustic receiver results in a received signal being generated by the acoustic receiver;
converting the received signal into a set of digital data indicative of a test fixture response;
identifying the test fixture response based on an analysis on the set of digital data;
generating resultant data associated with one or more characteristics of a real wellbore based on a comparison between data sensed at the real wellbore with the set of digital data indicative of the test fixture response; and
identifying the one or more characteristics of the real wellbore based on an analysis of the resultant data.

2. The method of claim 1, further comprising:
deploying the acoustic transmitter and the acoustic receiver in the test fixture that includes a set of structural elements that correspond to a group of structural elements of a real wellbore, wherein the comparison comprises subtracting data from the set of data indicative of the test fixture response from the data sensed at the real wellbore.

3. The method of claim 1, further comprising:
generating a first signal at a signal generator; and
providing the first signal to the acoustic transmitter, wherein the acoustic energy is emitted from the acoustic transmitter based on the first signal being provided to the acoustic transmitter.

4. The method of claim 1, further comprising:
emitting one or more additional pulses of acoustic energy from the acoustic transmitter;
receiving additional portions of acoustic energy associated with the one or more pulses of acoustic energy received by the acoustic receiver; and
converting the additional portions of acoustic energy into data that is included in the set of digital data.

5. The method of claim 4, wherein the pulse of acoustic energy and the one or more additional pulses of acoustic energy have different spectral content.

6. The method of claim 4, wherein the pulse of acoustic energy and the one or more additional pulses of acoustic energy have different spectral content each are associated with a specific sinusoid frequency.

7. The method of claim 1, further comprising:
collecting data at the real wellbore via one or more acoustic sensors of a passive acoustic sensing system, wherein the data associated with the one or more characteristics of the real wellbore are associated with specific locations or depths of the real wellbore.

8. A non-transitory computer-readable storage medium having embodied thereon instructions that when executed by one or more processors that cause the one or more processors to:
initiate an acoustic transmitter deployed in a test fixture to emit a of pulse of acoustic energy, wherein:
at least a portion of the pulse of acoustic energy is received by an acoustic receiver deployed in the test fixture,
the receipt of the at least portion of the pulse acoustic energy by the acoustic receiver results in a received signal being generated by the acoustic receiver, and
the received signal is converted into a set of digital data indicative of a test fixture response;
identify the test fixture response based on an analysis on the set of digital data;
generate resultant data associated with one or more characteristics of a real wellbore based on a comparison between data sensed at the real wellbore with the set of digital data indicative of the test fixture response; and
identify the one or more characteristics of the real wellbore based on an analysis of the resultant data.

9. The non-transitory computer-readable storage medium of claim 8, wherein the execution of the instructions cause the one or more processors to:
control the deployment of the acoustic transmitter and the acoustic receiver in the test fixture that includes a set of structural elements that correspond to a group of structural elements of a real wellbore, wherein the comparison comprises subtracting data from the set of data indicative of the test fixture response from the data sensed at the real wellbore.

10. The non-transitory computer-readable storage medium of claim 8, wherein the execution of the instructions cause the one or more processors to:
control generation of a first signal at a signal generator, wherein the first signal is provided to the acoustic transmitter, wherein the acoustic energy is emitted from the acoustic transmitter based on the first signal being provided to the acoustic transmitter.

11. The non-transitory computer-readable storage medium of claim 8, wherein the execution of the instructions cause the one or more processors to:
initiate emission of one or more additional pulses of acoustic energy from the acoustic transmitter, wherein:
additional portions of acoustic energy associated with the one or more pulses of acoustic energy received by the acoustic receiver are received, and
the additional portions of acoustic energy are converted into data that is included in the set of digital data.

12. The non-transitory computer-readable storage medium of claim 11, wherein the pulse of acoustic energy and the one or more additional pulses of acoustic energy have different spectral content.

13. The non-transitory computer-readable storage medium of claim 11, wherein the pulse of acoustic energy and the one or more additional pulses of acoustic energy have different spectral content each are associated with a specific sinusoid frequency.

14. The non-transitory computer-readable storage medium of claim 8, wherein:
data is collected at the real wellbore is based on deployment of one or more acoustic sensors at the real wellbore, wherein the data associated with the one or more characteristics of the real wellbore are associated with specific locations or depths of the real wellbore.

15. An apparatus comprising:
a test fixture that includes a set of structural elements that correspond to a group of structural elements of a real wellbore;
an acoustic transmitter deployed in the test fixture that emits a pulse of acoustic energy, wherein:
an acoustic receiver deployed in the test fixture that receives at least a portion of the pulse of acoustic energy, wherein:
the receipt of the at least portion of the pulse acoustic energy by the acoustic receiver results in a received signal being generated by the acoustic receiver, and
the received signal is converted into a set of digital data indicative of a test fixture response;
a memory; and
one or more processors that execute instructions out of the memory to:
identify the test fixture response based on an analysis on the set of digital data,
generate resultant data associated with one or more characteristics of a real wellbore based on a comparison between data sensed at the real wellbore with the set of digital data indicative of the test fixture response, and
identify the one or more characteristics of the real wellbore based on an analysis of the resultant data.

16. The apparatus of claim 15, wherein the execution of the instructions cause the one or more processors to:
control operation of the acoustic transmitter and the acoustic receiver in the test fixture that includes the set of structural elements that correspond to a group of structural elements of the real wellbore, wherein the comparison comprises subtracting data from the set of data indicative of the test fixture response from the data sensed at the real wellbore.

17. The apparatus of claim 15, wherein the execution of the instructions cause the one or more processors to:
control generation of a first signal at a signal generator, wherein the first signal is provided to the acoustic transmitter, wherein the acoustic energy is emitted from the acoustic transmitter based on the first signal being provided to the acoustic transmitter.

18. The apparatus of claim 15, wherein the execution of the instructions cause the one or more processors to:
initiate emission of one or more additional pulses of acoustic energy from the acoustic transmitter, wherein:
additional portions of acoustic energy associated with the one or more pulses of acoustic energy are received by the acoustic receiver, and
the additional portions of acoustic energy are converted into data that is included in the set of digital data.

19. The apparatus of claim 18, wherein the pulse of acoustic energy and the one or more additional pulses of acoustic energy have different spectral content.

20. The apparatus of claim 18, wherein the pulse of acoustic energy and the one or more additional pulses of acoustic energy have different spectral content each are associated with a specific sinusoid frequency.
